(19) United States
(12) Patent Application Publication
(10) Pub. No.: US 2020/0267765 A1
(43) Pub. Date: Aug. 20, 2020

(54) Method And Apparatus For Random Access Procedure With Listen-Before-Talk Detection In Mobile Communications

(71) Applicant: MediaTek Singapore Pte. Ltd., Singapore (SG)

(72) Inventors: Mehmet Kunt, Cambridge (GB); Pavan Santhana Krishna Nuggehalli, San Jose, CA (US)

(21) Appl. No.: 16/795,507

(22) Filed: Feb. 19, 2020

Related U.S. Application Data
(60) Provisional application No. 62/807,801, filed on Feb. 20, 2019.

(51) Int. Cl. H04W 74/08; H04W 76/18; H04W 80/02; H04W 76/11; H04L 1/18

(52) U.S. Cl. CPC H04W 74/0808; H04W 76/18; H04L 1/1835; H04W 76/11; H04L 1/1812; H04W 80/02

(57) ABSTRACT

Various solutions for random access procedure with listen-before-talk (LBT) detection with respect to user equipment and network apparatus in mobile communications are described. An apparatus may initiate a random access preamble transmission. The apparatus may perform an LBT procedure before the random access preamble transmission. The apparatus may determine whether the LBT procedure has failed. The apparatus may perform a random access resource selection procedure in an event that the LBT procedure has failed.

### CROSS REFERENCE TO RELATED PATENT APPLICATION(S)

The present disclosure is part of a non-provisional application claiming the priority benefit of U.S. Patent Application No. 62/807,801, filed on 20 Feb. 2019, the content of which being incorporated by reference in its entirety.

### TECHNICAL FIELD

The present disclosure is generally related to mobile communications and, more particularly, to random access procedure with listen-before-talk (LBT) procedure/detection with respect to user equipment and network apparatus in mobile communications.

### BACKGROUND

Unless otherwise indicated herein, approaches described in this section are not prior art to the claims listed below and are not admitted as prior art by inclusion in this section.

In unlicensed spectrum communication, the LBT mechanism is proposed to avoid interference and coordinate access to the channel for multiple devices. LBT procedure/detection is defined as a mechanism by which an equipment applies clear channel assessment (CCA) before using a channel. Specifically, before transmission, a device shall perform a CCA check and listen for the duration of the CCA observation time on its operating channel. The channel shall be considered occupied if the energy level in the channel exceeds a threshold value. If the device finds the channel occupied, the device shall delay further attempts to access the medium. The channel shall be considered available if the energy level in the channel is below a threshold value. The device shall be able to access the channel and perform transmissions at the moment.

For New Radio (NR) in licensed spectrum, when the media access control (MAC) layer instructs the physical layer to perform an uplink transmission, in most cases the MAC layer assumes that the uplink transmission will be performed by the physical layer. For NR in unlicensed spectrum (NR-U), for unlicensed access, the physical layer has to perform the LBT procedure before performing the uplink transmission. In an event that the LBT detection is successful, the physical layer will perform the uplink transmission. In an event that the LBT procedure is failed, the physical layer will not perform the uplink transmission.

In an event that the uplink transmission is not performed by the physical layer due to the LBT failure, if the physical layer does not inform the MAC layer about the result of the LBT detection, the MAC layer will assume that the uplink transmission is performed by the physical layer and keep waiting for the response message. This will cause unnecessary waiting for the MAC layer. The MAC layer will not know which step it should take next. It is not clear how the MAC layer should react under such scenario. Hence, the random-access procedure could fail or be delayed for a long period of time, and the UE will not be able to perform uplink transmissions during this time. User experience will be impacted adversely due to such issues.

Accordingly, how to improve the random access procedure for NR-U becomes an important aspect for the newly developed wireless communication network. Therefore, it is needed to provide and define clear steps for the UE to perform the random access procedure with the LBT procedure/detection.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to random access procedure with LBT detection with respect to user equipment and network apparatus in mobile communications.

In one aspect, a method may involve an apparatus initiating a random access preamble transmission. The method may also involve the apparatus performing an LBT procedure before the random access preamble transmission. The method may further involve the apparatus determining whether the LBT procedure is failed. The method may further involve the apparatus performing, by the processor, a random access resource selection procedure in an event that the LBT procedure is failed.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising initiating a random access preamble transmission. The processor may also perform operations comprising performing an LBT procedure before the random access preamble transmission. The processor may further perform operations comprising determining whether the LBT procedure is failed. The processor may further perform operations comprising performing a random access resource selection procedure in an event that the LBT procedure is failed.

It is noteworthy that, although the description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT) and Industrial Internet of Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to random access procedure with LBT detection with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

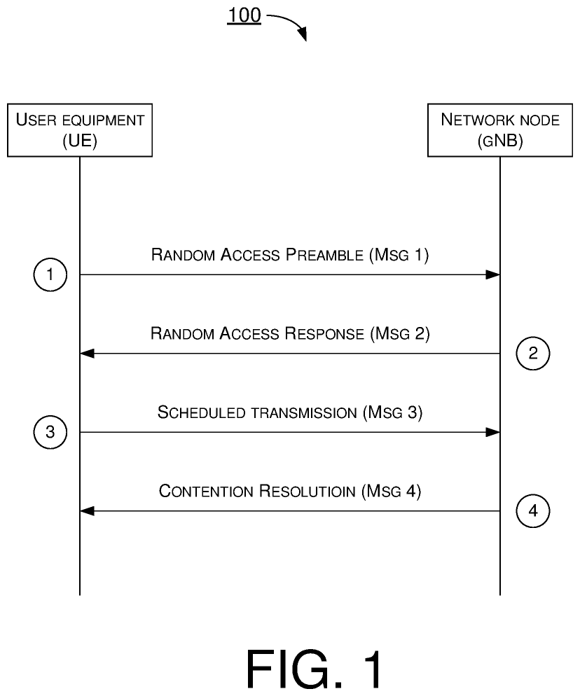

FIG. 1 illustrates an example scenario 100 under schemes in accordance with implementations of the present disclosure. Scenario 100 involves a UE and a network node (e.g., gNB), which may be a part of a wireless communication network (e.g., an LTE network, an LTE-Advanced network, an LTE-Advanced Pro network, a 5G network, an NR network, an IoT network, an NB-IoT network or an IoT network). Scenario 100 illustrates a 4-step random access channel (RACH) procedure. For reasons such as obtaining resources for uplink transmissions, establishing uplink time alignment, or requesting other system information (SI), the UE may be configured to initiate the RACH procedure. Firstly, the UE may be configured to transmit a random access preamble message (e.g., message 1 (Msg 1)) to the network node. Secondly, the network node may reply a random access response message (e.g., message 2 (Msg 2)) to the UE. Thirdly, the UE may further transmit a scheduled transmission message (e.g., message 3 (Msg 3)) to the network node. Fourthly, the network node may transmit a contention resolution message (e.g., message 4 (Msg 4)) to the UE. Then the RACH procedure could be finished and the UE may be able to perform uplink transmissions, having established the uplink time alignment.

On the other hand, in unlicensed spectrum communication, the LBT mechanism is proposed to avoid interferences between multiple devices and to coordinate the channel access for multiple devices. LBT procedure/detection is defined as a mechanism by which an equipment applies CCA before using a channel. Specifically, before transmission, a device shall perform a CCA check and listen for the duration of the CCA observation time on its operating channel. The channel shall be considered occupied if the energy level in the channel exceeds a threshold value. If the device finds the channel occupied, the device shall delay further attempts to access the medium. The channel shall be considered available if the energy level in the channel is below a threshold value. The device shall be able to access the channel and perform transmissions at the moment.

For NR in licensed spectrum, when the media access control (MAC) layer instructs the physical layer to perform an uplink transmission, in most cases the MAC layer assumes that the uplink transmission will be performed by the physical layer. For NR in unlicensed spectrum (NR-U), for unlicensed access, the physical layer has to perform the LBT detection before performing the uplink transmission. In an event that the LBT detection is successful, the physical layer will perform the uplink transmission. In an event that the LBT detection is failed, the physical layer will not perform the uplink transmission.

In an event that the uplink transmission is not performed by the physical layer due to the LBT failure, if the physical layer does not inform the MAC layer about the result of the LBT detection, the MAC layer will assume that the uplink transmission is performed by the physical layer and keep waiting for the random access response message (e.g., Msg 2). This will cause unnecessary waiting for the MAC layer. The MAC layer will not know which step it should take next. It is not clear how the MAC layer should react under such scenario. Hence, the random-access procedure could fail or delayed for a long period of time and the UE will not be able to perform uplink transmissions during this time. User experience will be impacted adversely due to such issues.

Similarly, the message 3 (Msg 3) transmission in the RACH procedure may have the same issue. When the MAC layer instructs the physical layer to transmit the message 3 of the RACH procedure, the physical layer may perform the LBT detection before transmitting the message 3. In an event that the uplink transmission is not performed by the physical layer due to the LBT failure, the physical layer will not inform the MAC layer about the result of the LBT detection. The MAC layer will assume that the uplink transmission is performed by the physical layer and keep waiting for the contention resolution message (e.g., Msg 4). It is also not clear how the MAC layer should react under such scenario. Hence, the random-access procedure could also fail or take a longer time due to the failure of the message 3 transmission.

In view of the above, the present disclosure proposes a number of schemes pertaining to random access procedure with LBT detection with respect to the UE and the network apparatus. According to the schemes of the present disclosure, the physical layer may be configured to indicate a result of the LBT procedure to the MAC layer. In an event that the uplink transmission does not performed due to the LBT failure, the physical layer may transmit an LBT failure indication to the MAC layer. In an event that the LBT failure indication is received from the physical layer, the MAC layer may be configured to return to the random-access resource selection step in the random-access procedure. Accordingly, the MAC layer may have a clear indication whether the random-access preamble is transmitted or not. The MAC layer may be able to properly determine the next step according to the indication without unnecessary waiting. The whole random-access procedure becomes more efficient and can be finished properly.

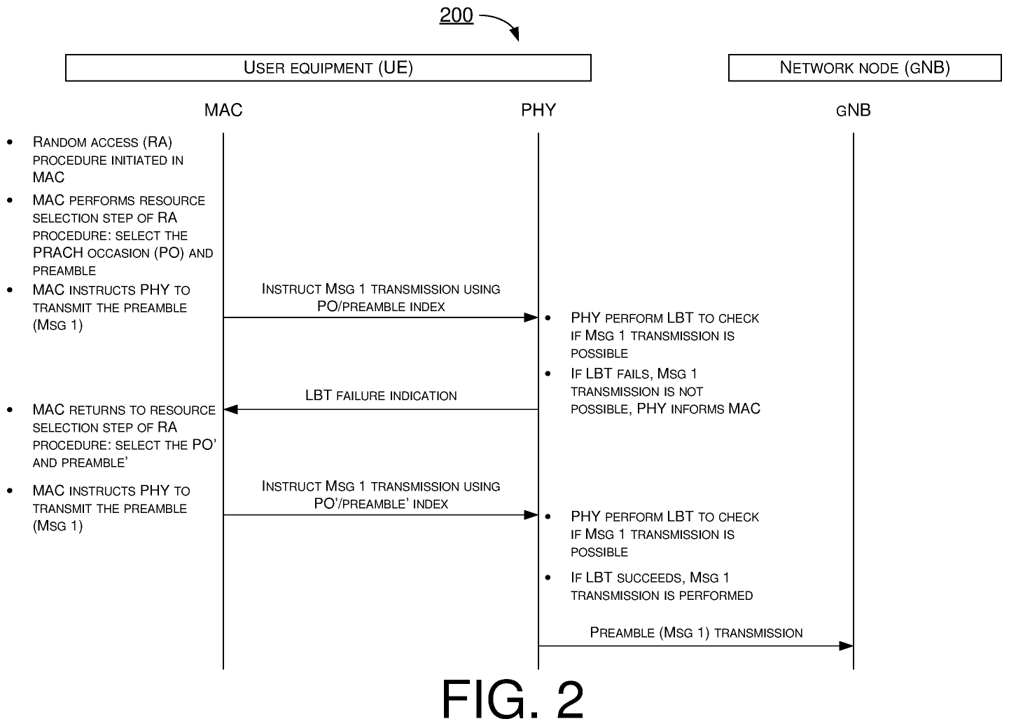

FIG. 2 illustrates an example scenario 200 under schemes in accordance with implementations of the present disclosure. Scenario 200 involves a UE and a network node (e.g., gNB), which may be a part of a wireless communication network (e.g., an LTE network, an LTE-Advanced network, an LTE-Advanced Pro network, a 5G network, an NR network, an IoT network, an NB-IoT network or an IIoT network). The network node may be operated with a serving cell of the UE. Scenario 200 illustrates a RACH procedure in accordance with implementations of the present disclosure. The UE may comprise a MAC layer (MAC) and a physical layer (PHY). The MAC layer may comprise a MAC entity. The physical layer may comprise a PHY entity. The MAC layer and/or the physical layer may be implemented by a software component, a hardware component, or a combination thereof in a processor of the UE. The MAC layer may be configured as a higher layer for the physical layer. The physical layer may be configured as a lower layer of the MAC layer. The MAC layer and the physical layer may be able to communicate with each other. The UE may also comprise other layers which will not be described herein.

To transmit uplink data or communicate with the network node, the UE may be configured to initiate the random access procedure. Firstly, the UE may be configured to initiate the random access preamble transmission. The UE may be configured to perform the LBT procedure before the random-access preamble transmission. The UE may be configured to determine a result of the LBT procedure. The UE may be configured to determine a next procedure/step according to the result of the LBT procedure. For example, in an event that the LBT procedure is failed, the UE may be configured to perform the random access resource selection procedure. In an event that the LBT procedure is successful, the UE may be configured to perform the random access response reception procedure.

Specifically, the random access procedure may be cooperatively executed by the physical layer, the MAC layer and other layers. For the MAC layer, when the random access procedure is initiated in the MAC layer, the MAC layer may be configured to perform the random access resource selection step of the random access procedure. The MAC layer may select the physical random-access channel (PRACH) occasion (PO) and the preamble. Then, the MAC layer may instruct the lower layer (e.g., the physical layer) to transmit the preamble. The MAC layer may instruct the message 1 (Msg 1) transmission using the PO and preamble index to the physical layer.

For the physical layer, after receiving the instruction from the MAC layer, the physical layer may be configured to perform the LBT procedure/detection to check if the Msg 1 transmission is possible. The physical layer may be configured to determine a result of the LBT procedure and indicate the result to the MAC layer. In an event that the LBT procedure is successful (e.g., the channel is available), the physical layer may be configured to transmit the Msg 1 to the network node. Then, the UE may expect to receive the Msg 2 from the network node. In an event that the LBT procedure is failed (e.g., the channel is occupied), the physical layer may determine that the Msg 1 transmission is not possible. Then, the physical layer may be configured to transmit the LBT failure indication to the MAC layer.

After receiving the LBT failure indication from the lower layer (e.g., physical layer), the MAC layer may be aware of that the Msg 1 transmission has failed and the preamble was not transmitted by the physical layer. Correspondingly, the MAC layer may be configured to re-initiate the random-access preamble transmission to retransmit a preamble. The MAC layer may be configured to return to the random access resource selection step of the random access procedure. The MAC layer may be configured to select another PO (e.g., PO′) and another preamble (e.g., preamble′). Then, the MAC layer may instruct the physical layer to transmit the selected preamble. The MAC layer may instruct the Msg 1 transmission using the PO′ and preamble′ index to the physical layer.

Again, after receiving the instruction from the MAC layer, the physical layer may be configured to perform the LBT procedure/detection to check if the Msg 1 transmission is possible. The physical layer may be configured to determine a result of the LBT procedure. In an event that the LBT procedure is successful (e.g., the channel is available), the physical layer may be configured to transmit the Msg 1 to the network node. Then, the UE may expect to receive the Msg 2 from the network node. The physical layer may be further configured to transmit an indication to inform the MAC layer that the preamble is transmitted or the Msg 1 transmission is successful.

In an event that Msg 1 transmission is successful or after receiving the success indication from the physical layer, the MAC layer may be configured to progress to the random access response reception step in the random access procedure. Accordingly, with the indication from the physical layer, the MAC may have clear information about the result of the LBT procedure and whether the Msg 1 transmission is performed or not. The MAC layer may be able to determine a next procedure/step according to the indication from the physical layer. Thus, the MAC layer will not waste time by unnecessary waiting and the random-access procedure may be continued unhindered.

In some implementations, the UE may be configured to receive a configuration to enable the indicating of the result of the LBT procedure. The configuration may comprise, for example and without limitations, a radio resource control (RRC) configuration, a system information (SI) or a dedicated RRC signaling from the serving cell. The physical layer shall indicate a result of uplink transmission to the MAC layer in an event that the physical layer is configured to enable/perform the indication of the transmission result to the MAC layer for the serving cell where the random access procedure is being performed.

In some implementations, the UE may be configured to determine whether the random-access preamble transmission is performed in an unlicensed spectrum. In an event that the random access preamble transmission is performed in the unlicensed spectrum, the UE may be configured to enable the indicating of the result of the LBT procedure. In an event that the random access preamble transmission is performed in the licensed spectrum, the UE may not need to enable the indicating of the result of the LBT procedure.

In some implementations, in an event that the LBT procedure has failed, the UE may be configured to perform the random-access resource selection procedure immediately. Alternatively, in an event that the LBT procedure is failed, the UE may be configured to perform the random-access resource selection procedure when a backoff timer has expired. Specifically, after receiving the LBT failure indication from the physical layer, the MAC layer may be configured to return to the the random-access resource selection step immediately or after a backoff timer has expired. The backoff timer may be selected within minimum-maximum limits which pre-stored in the UE or configured by the RRC, SI or dedicated signalling. The backoff timer may also be selected by using the backoff indicator (BI) if received in the Msg2. The backoff timer may also be indicated by lower layers (e.g., physical layer).

In some implementations, the MAC layer may be configured to return to the random-access resource selection step in an event that no indication of a result of the LBT procedure is received from the lower layer. The MAC layer may initiate a timer to count if an indication is received from the lower layer. The MAC layer may reset the timer in an event that an indication is received from the lower layer. When the timer is expired and no indication is received, the MAC layer may return to the random access resource selection step.

Similarly, the same schemes mentioned above may be applied to the Msg 3 transmission as well. After receiving the random-access response message (e.g., Msg 2) from the network node, the UE may be configured to perform a scheduled transmission (e.g., physical uplink shared channel (PUSCH) transmission) in the random-access procedure. The UE may be configured to initiate the Msg 3 transmission. The UE may be configured to perform the LBT procedure before the Msg 3 transmission. The UE may be configured to determine a result of the LBT procedure. The UE may be configured to perform an action according to the result of the LBT procedure. For example, in an event that the LBT procedure is failed, the UE may be configured to perform the random access resource selection procedure. In an event that the LBT procedure is successful, the UE may be configured to perform the contention resolution reception procedure.

Specifically, the MAC layer may instruct the Msg 3 transmission to the physical layer. The physical layer may be configured to perform the LBT procedure/detection to check if the Msg 3 transmission is possible. The physical layer may be configured to determine a result of the LBT procedure and indicate the result to the MAC layer. In an event that the LBT procedure is successful (e.g., the channel is available), the physical layer may be configured to transmit the Msg 3 to the network node. Then, the physical layer may expect to receive the Msg 4 from the network node. In an event that the LBT procedure is failed (e.g., the channel is occupied), the physical layer may determine that the Msg 3 transmission is not possible. Then, the physical layer may be configured to transmit the LBT failure indication to the MAC layer.

After receiving the LBT failure indication from the physical layer, the MAC layer may be configured to return to the random access preamble transmission to retransmit a preamble. The MAC layer may be configured to return to the random access resource selection step of the random access procedure.

In an event that Msg 3 transmission is successful or after receiving the success indication from the physical layer, the MAC layer may be configured to progress to the contention resolution reception step in the random access procedure. Accordingly, with the indication from the physical layer, the MAC may have clear information about the result of the LBT procedure and whether the Msg 3 transmission is performed or not. The MAC layer may be able to perform an action according to the indication from the physical layer. Thus, the MAC layer will not waste time by unnecessary waiting and the random-access procedure may be continued unhindered.

In some implementations, the UE may be configured to perform other actions in an event that the LBT failure indication is received for the Msg 3 transmission. For example, the UE may be configured to determine whether the Msg 3 transmission is failed. In an event that the Msg 3 transmission is failed, the UE may be configured to discard a temporary cell-radio network temporary identifier (TC-RNTI) received in the random-access response message (e.g., Msg 2). In another example, in an event that the Msg 3 transmission is failed, the UE may be configured to flush a hybrid automatic repeat request (HARQ) buffer. In a further example, in an event that the Msg 3 transmission is failed, the UE may be configured to increase a counter (e.g., PREAMBLE_TRANSMISSION_COUNTER) to count how many times the preamble is transmitted. In an event that the counter reaches a maximum limit (e.g., preambleTransMax+1), the MAC layer may be configured to indicate a random-access problem to upper layers. In a further example, the MAC layer may consider the random-access procedure unsuccessfully completed in an event that the random-access procedure is triggered for SI request. In a further example, the MAC layer may return to the random access resource selection step in the random access procedure in an event that the counter reaches a maximum limit (e.g., PREAMBLE_TRANSMISSION_COUNTER=preambleTransMax+1) and in an event that the random access procedure is not completed.

Illustrative Implementations

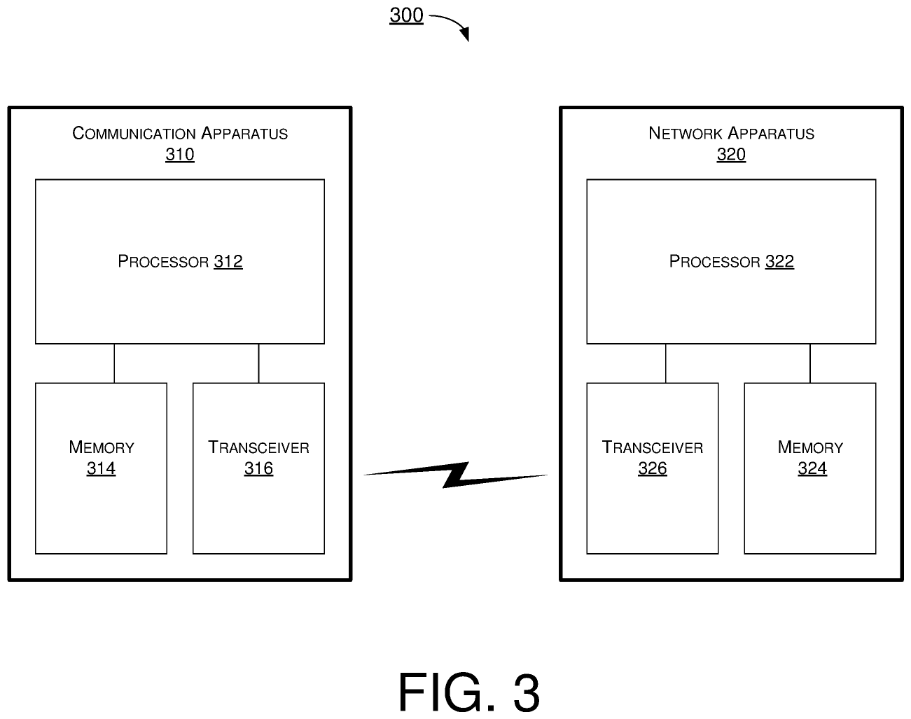

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to random access procedure with LBT detection with respect to user equipment and network apparatus in wireless communications, including scenarios/schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may comprise a MAC layer and a physical layer. Processor 312 may comprise a MAC entity a PHY entity. The MAC layer and/or the physical layer of processor 312 may be implemented by a software component, a hardware component, or a combination thereof. The MAC layer may be configured as a higher layer for the physical layer. The physical layer may be configured as a lower layer of the MAC layer. The MAC layer and the physical layer may be able to communication with each other. Processor 312 may also comprise other layers which will not be described herein.

In some implementations, processor 312 may be configured to initiate the random access procedure. Firstly, processor 312 may be configured to initiate the random access preamble transmission. Processor 312 may be configured to perform the LBT procedure before the random access preamble transmission. Processor 312 may be configured to determine a result of the LBT procedure. Processor 312 may be configured to determine a next procedure/step according to the result of the LBT procedure. For example, in an event that the LBT procedure is failed, processor 312 may be configured to perform the random access resource selection procedure. In an event that the LBT procedure is successful, processor 312 may be configured to perform the random access response reception procedure.

In some implementations, processor 312 may enable the physical layer, the MAC layer and other layers to perform the random access procedure cooperatively. When the random access procedure is initiated by processor 312, processor 312 may enable the MAC layer to perform the random access resource selection step of the random access procedure. Processor 312 may enable the MAC layer to select the PO and the preamble. Then, processor 312 may enable the MAC layer to instruct the lower layer (e.g., the physical layer) to transmit the preamble. Processor 312 may enable the MAC layer to instruct the Msg 1 transmission using the PO and preamble index to the physical layer.

In some implementations, processor 312 may enable the physical layer to perform the LBT procedure/detection to check if the Msg 1 transmission is possible. Processor 312 may enable the physical layer to determine a result of the LBT procedure and indicate the result to the MAC layer. In an event that the LBT procedure is successful (e.g., the channel is available), processor 312 may enable the physical layer to transmit the Msg 1 to the network node. In an event that the LBT procedure is failed (e.g., the channel is occupied), processor 312 may enable the physical layer to transmit the LBT failure indication to the MAC layer.

In some implementations, processor 312 may enable the MAC layer to re-initiate the random access preamble transmission to retransmit a preamble after receiving the LBT failure indication from the lower layer. Processor 312 may enable the MAC layer to return to the random access resource selection step of the random access procedure. Processor 312 may enable the MAC layer to select another PO and another preamble. Processor 312 may enable the MAC layer to instruct the Msg 1 transmission using the PO′ and preamble′ index to the physical layer.

In some implementations, processor 312 may enable the physical layer to transmit the Msg 1 to the network apparatus 320 in an event that the LBT procedure is successful. Processor 312 may enable the physical layer to transmit an indication to inform the MAC layer that the preamble is transmitted or the Msg 1 transmission is successful.

In some implementations, processor 312 may enable the MAC layer to progress to the random access response reception step in the random access procedure in an event that Msg 1 transmission is successful or after receiving the success indication from the physical layer. Processor 312 may enable the MAC layer to determine a next procedure/step according to the indication from the physical layer.

In some implementations, processor 312 may be configured to receive, via transceiver 316, a configuration to enable the physical layer to indicate the result of the LBT procedure. Processor 312 may enable the physical layer to indicate a result of uplink transmission to the MAC layer in an event that the physical layer is configured to enable/perform the indication of the transmission result to the MAC layer for network apparatus 320 where the random access procedure is being performed.

In some implementations, processor 312 may be configured to determine whether the random-access preamble transmission is performed in an unlicensed spectrum. In an event that the random access preamble transmission is performed in the unlicensed spectrum, processor 312 may be configured to enable the physical layer to indicate the result of the LBT procedure. In an event that the random access preamble transmission is performed in the licensed spectrum, processor 312 may not need to enable the physical layer to indicate the result of the LBT procedure.

In some implementations, in an event that the LBT procedure is failed, processor 312 may be configured to perform the random-access resource selection procedure immediately or after a backoff timer has expired. Specifically, after receiving the LBT failure indication from the physical layer, processor 312 may enable the MAC layer to return to the the random-access resource selection step immediately or after a backoff timer has expired. Processor 312 may select the backoff timer within minimum-maximum limits which pre-stored in memory 314 or configured by the RRC, SI or dedicated signalling. Processor 312 may also select the backoff timer by using the BI if received in the Msg2.

In some implementations, processor 312 may enable the MAC layer to return to the random-access resource selection step in an event that no indication of a result of the LBT procedure is received from the lower layer. Processor 312 may enable the MAC layer to initiate a timer to count if an indication is received from the lower layer. Processor 312 may enable the MAC layer to reset the timer in an event that an indication is received from the lower layer. When the timer is expired and no indication is received, Processor 312 may enable the MAC layer to return to the random access resource selection step.

In some implementations, after receiving the Msg 2 from network apparatus 320, processor 312 may be configured to perform a scheduled transmission (e.g., PUSCH transmission) in the random-access procedure. Processor 312 may be configured to initiate the Msg 3 transmission. Processor 312 may be configured to perform the LBT procedure before the Msg 3 transmission. Processor 312 may be configured to determine a result of the LBT procedure. Processor 312 may be configured to perform an action according to the result of the LBT procedure. For example, in an event that the LBT procedure has failed, processor 312 may be configured to perform the random access resource selection procedure. In an event that the LBT procedure is successful, processor 312 may be configured to perform the contention resolution reception procedure.

In some implementations, processor 312 may enable the MAC layer to instruct the Msg 3 transmission to the physical layer. Processor 312 may enable the physical layer to perform the LBT procedure/detection to check if the Msg 3 transmission is possible. Processor 312 may enable the physical layer to determine a result of the LBT procedure and indicate the result to the MAC layer. In an event that the LBT procedure is successful (e.g., the channel is available), processor 312 may enable the physical layer to transmit the Msg 3 to network apparatus 320. Then, processor 312 may expect to receive the Msg 4 from network apparatus 320. In an event that the LBT procedure has failed (e.g., the channel is occupied), processor 312 may enable the physical layer to transmit the LBT failure indication to the MAC layer.

In some implementations, processor 312 may enable the MAC layer to return to the random-access preamble transmission to retransmit a preamble after receiving the LBT failure indication from the physical layer. Processor 312 may enable the MAC layer to return to the random-access resource selection step of the random-access procedure.

In some implementations, processor 312 may enable the MAC layer to progress to the contention resolution reception step in the random-access procedure in an event that Msg 3 transmission is successful or after receiving the success indication from the physical layer. Processor 312 may enable the MAC layer to perform an action according to the indication from the physical layer.

In some implementations, processor 312 may enable the MAC layer to perform other actions in an event that the LBT failure indication is received for the Msg 3 transmission. For example, processor 312 may be configured to determine whether the Msg 3 transmission has failed. In an event that the Msg 3 transmission is failed, processor 312 may be configured to discard a TC-RNTI received in the Msg 2. In another example, in an event that the Msg 3 transmission has failed, processor 312 may be configured to flush a HARQ buffer. In a further example, in an event that the Msg 3 transmission has failed, processor 312 may be configured to increase a counter to count how many times the preamble is transmitted. In an event that the counter reaches a maximum limit, processor 312 may enable the MAC layer to indicate a random-access problem to upper layers. In a further example, processor 312 may enable the MAC layer to consider the random-access procedure unsuccessfully completed in an event that the random-access procedure is triggered for SI request. In a further example, processor 312 may enable the MAC layer to return to the random-access resource selection step in the random access procedure in an event that the counter reaches a maximum limit and in an event that the random access procedure is not completed.

### Illustrative Processes

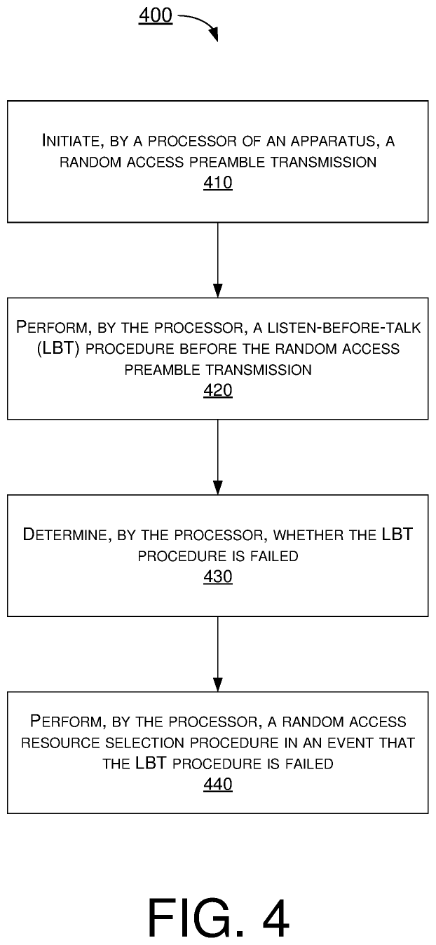

FIG. 4 illustrates an example process 400 in accordance with an implementation of the present disclosure. Process 400 may be an example implementation of above scenarios/schemes, whether partially or completely, with respect to random access procedure with LBT detection with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 initiating a random access preamble transmission. Process 400 may proceed from 410 to 420.

At 420, process 400 may involve processor 312 performing an LBT procedure before the random access preamble transmission. Process 400 may proceed from 420 to 430.

At 430, process 400 may involve processor 312 determining whether the LBT procedure has failed. Process 400 may proceed from 430 to 440.

At 440, process 400 may involve processor 312 performing a random access resource selection procedure in an event that the LBT procedure has failed.

In some implementations, process 400 may involve the MAC layer of processor 312 receiving an LBT failure indication from a lower layer in an event that the LBT procedure has failed.

In some implementations, process 400 may involve the physical layer of processor 312 indicating a result of the LBT procedure to the MAC layer.

In some implementations, process 400 may involve processor 312 receiving a configuration to enable the indicating of the result of the LBT procedure.

In some implementations, process 400 may involve processor 312 determining whether the random access preamble transmission is performed in an unlicensed spectrum. Process 400 may further involve processor 312 enabling the indicating of the result of the LBT procedure in an event that the random access preamble transmission is performed in the unlicensed spectrum.

In some implementations, process 400 may involve the MAC layer of processor 312 performing the random access resource selection procedure in an event that no indication of a result of the LBT procedure is received from a lower layer.

In some implementations, process 400 may involve processor 312 performing a random access response reception procedure in an event that the LBT procedure is successful.

In some implementations, process 400 may involve processor 312 performing the random access resource selection procedure when a backoff timer has expired in an event that the LBT procedure has failed.

In some implementations, process 400 may involve processor 312 determining whether a message 3 transmission has failed. Process 400 may further involve processor 312 discarding a TC-RNTI received in a random access response message in an event that the message 3 transmission has failed.

In some implementations, process 400 may involve processor 312 determining whether a message 3 transmission has failed. Process 400 may further involve processor 312 flushing a HARQ buffer in an event that the message 3 transmission has failed.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
initiating, by a processor of an apparatus, a random access preamble transmission;
performing, by the processor, a listen-before-talk (LBT) procedure before the random access preamble transmission;
determining, by the processor, whether the LBT procedure has failed; and
performing, by the processor, a random access resource selection procedure in an event that the LBT procedure has failed.

2. The method of claim 1, further comprising:
receiving, by a media access control (MAC) layer of the processor, an LBT failure indication from a lower layer in an event that the LBT procedure has failed.

3. The method of claim 1, further comprising:
indicating, by a physical layer of the processor, a result of the LBT procedure to a media access control (MAC) layer.

4. The method of claim 3, further comprising:
receiving, by the processor, a configuration to enable the indicating of the result of the LBT procedure.

5. The method of claim 3, further comprising:
determining, by the processor, whether the random access preamble transmission is performed in an unlicensed spectrum; and
enabling, by the processor, the indicating of the result of the LBT procedure in an event that the random access preamble transmission is performed in the unlicensed spectrum.

6. The method of claim 3, further comprising:
performing, by the processor, a random access response reception procedure in an event that the LBT procedure is successful.

7. The method of claim 1, further comprising:
performing, by a media access control (MAC) layer of the processor, the random access resource selection procedure in an event that no indication of a result of the LBT procedure is received from a lower layer.

8. The method of claim 1, wherein the performing comprises performing the random access resource selection procedure when a backoff timer is expired in an event that the LBT procedure is failed.

9. The method of claim 1, further comprising:
determining, by the processor, whether a message 3 transmission has failed; and
discarding, by the processor, a temporary cell-radio network temporary identifier (TC-RNTI) received in a random access response message in an event that the message 3 transmission has failed.

10. The method of claim 1, further comprising:
determining, by the processor, whether a message 3 transmission has failed; and
flushing, by the processor, a hybrid automatic repeat request (HARQ) buffer in an event that the message 3 transmission has failed.

11. An apparatus, comprising:
a transceiver which, during operation, wirelessly communicates with network nodes of a wireless network; and
a processor communicatively coupled to the transceiver such that, during operation, the processor performs operations comprising:
initiating a random access preamble transmission;
performing a listen-before-talk (LBT) procedure before the random access preamble transmission;
determining whether the LBT procedure has failed; and
performing a random access resource selection procedure in an event that the LBT procedure has failed.

12. The apparatus of claim 11, wherein, during operation, a media access control (MAC) layer of the processor further performs operations comprising:
receiving an LBT failure indication from a lower layer in an event that the LBT procedure has failed.

13. The apparatus of claim 11, wherein, during operation, a physical layer of the processor further performs operations comprising:
indicating a result of the LBT procedure to a media access control (MAC) layer.

14. The apparatus of claim 13, wherein, during operation, the processor further performs operations comprising:
receiving, via the transceiver, a configuration to enable the indicating of the result of the LBT procedure.

15. The apparatus of claim 13, wherein, during operation, the processor further performs operations comprising:
determining whether the random access preamble transmission is performed in an unlicensed spectrum; and
enabling the indicating of the result of the LBT procedure in an event that the random access preamble transmission is performed in the unlicensed spectrum.

16. The apparatus of claim 13, wherein, during operation, the processor further performs operations comprising:
performing, via the transceiver, a random access response reception procedure in an event that the LBT procedure is successful.

17. The apparatus of claim 11, wherein, during operation, a media access control (MAC) layer of the processor further performs operations comprising:
performing the random access resource selection procedure in an event that no indication of a result of the LBT procedure is received from a lower layer.

18. The apparatus of claim 11, wherein, in performing the random access resource selection procedure, the processor performs the random access resource selection procedure when a backoff timer has expired in an event that the LBT procedure has failed.

19. The apparatus of claim 11, wherein, during operation, the processor further performs operations comprising:
determining whether a message 3 transmission has failed; and
discarding a temporary cell-radio network temporary identifier (TC-RNTI) received in a random access response message in an event that the message 3 transmission has failed.

20. The apparatus of claim 11, wherein, during operation, the processor further performs operations comprising:
determining whether a message 3 transmission has failed; and
flushing a hybrid automatic repeat request (HARQ) buffer in an event that the message 3 transmission has failed.
